(19) United States
(12) Patent Application Publication
(10) Pub. No.: US 2005/0029822 A1
(43) Pub. Date: Feb. 10, 2005

(54) Bumper reinforcing structure of automobile

(76) Inventor: Hwa-sun Lee, Chungcheongnam-do (KR)

Correspondence Address: KNOBBE MARTENS OLSON & BEAR LLP, 2040 MAIN STREET, FOURTEENTH FLOOR, IRVINE, CA, 92614, US

(21) Appl. No.: 10/873,629

(22) Filed: Jun. 22, 2004

(30) Foreign Application Priority Data
Jun. 23, 2003 (KR) 2003-40600

(51) Int. Cl. B60R 19/24

(52) U.S. Cl. 293/155

(57) ABSTRACT

A bumper reinforcing structure for an automobile, which is made of two or more different materials. The bumper reinforcing structure includes an impact beam, a mounting part connected to either end of the impact beam, and a connecting portion for connecting the impact beam and the mounting part to each other at either end of the impact beam, wherein the impact beam and the mounting part are formed from two or more different materials. Among the components of the bumper reinforcing structure, a portion, which requires stiffness, is made of a material having a high strength, while a portion, which is readily deformable, is made of a material having a high impact absorbency, so that the bumper reinforcing structure can effectively absorb impact energy upon collision, thereby maximizing the energy absorbing efficiency.

### RELATED APPLICATIONS

This application claims priority under 35 U.S.C. §119 to Korean Application No. 2003-40600 filed Jun. 23, 2003, which is herein incorporated by reference in its entirety.

### BACKGROUND OF THE INVENTION

1. Field of the Invention

The present invention relates to a bumper reinforcing structure of an automobile, and more particularly to a bumper reinforcing structure of an automobile, which is made of two or more different materials.

2. Description of the Related Art

As a component of an automobile, a bumper is mounted at front and rear sides of the automobile to absorb impact energy upon collision caused by traffic accidents, thereby protecting a body frame and securing safety of a driver in the automobile. Specifically, a front bumper is mounted at the front side of the automobile to protect a hood constituting the body frame and many kinds of components, such as an engine mounted in an engine compartment, and a rear bumper is mounted at the rear side for the same purpose as that of the front bumper.

The bumper must have a standardized strength, and be structured such that the body frame can be protected by a buffering force of the bumper having such a standardized strength without being broken upon a low speed collision of the automobile and such that an impact can be prevented from being transmitted to the engine compartment simultaneously with the buffering effect.

In general, the automobile bumper comprises a bumper face, which is the outer and more visible portion of the bumper, an energy absorber for absorbing the impact from the outside upon collision, a reinforcing structure for protecting the body frame by shielding the impact from the outside, and a bumper mounting bracket for fixing the bumper to the frame. The reinforcing structure includes an impact beam, which is directly exposed to the impact from the outside, and a mounting part for sustaining a force applied to the impact beam while supporting the impact beam. The reinforcing structure consists of a material, such as metal, synthetic resin containing glass fiber or the like, and is manufactured as an integral component. Since the impact beam and the mounting part are manufactured as an integral component in the conventional bumper reinforcing structure of the automobile, partial damage inflicted on any one of the components necessitates replacement of the entire bumper reinforcing structure, thereby requiring time and cost for the replacement.

A problem with the metal reinforcing structure is its weight. The synthetic resin containing the glass fiber is expensive, thereby increasing manufacturing costs when manufacturing the reinforcing structure with the synthetic resin. That is, since the reinforcing structure is made of a single material as an integral component, there are problems of high price or heavy weight.

Moreover, allowing that the moment and the force caused by the collision are concentrated on the mounting part, it can be suggested to reduce damage of the mounting part itself by increasing strength of the mounting part. However, since an increase in strength of the mounting part would cause all the impact absorbed by the mounting part to be transmitted to the body frame, this suggestion is inappropriate in view of protection of the driver. Additionally, since the reinforcing structure comprising the mounting part is integrally manufactured, an increase in weight of the mounting part is accompanied with an increase in weight of the bumper, thereby reducing economical efficiency.

Since reduction in strength of the mounting part for solving the above problems causes deformation of the mounting part upon collision to be increased, the bumper must be increased in size in order to secure a deformation space, resulting in a poor appearance. Moreover, even though the mounting part is designed such that the impact directly transmitted to the driver can be reduced in such a manner that the mounting part is broken upon collision, the breakage of the mounting part is followed by replacement of the entire reinforcing structure due to the fact that the mounting part is integrated with the reinforcing structure as an integral component, thereby remarkably increasing the economical burden for replacing the damaged reinforcing structure with a new one.

Further, since the mounting part and the impact beam are produced as an integral component of the reinforcing structure, in a case where the mounting part is made of a material having a weak stiffness as described above, the impact beam is also formed from the same material having weak stiffness. As a result, there are provided structural drawbacks in that the impact beam, which is required to have a relatively high stiffness, has a reduced stiffness.

### SUMMARY OF THE CERTAIN INVENTIVE ASPECTS

Embodiments of the present invention has been made to solve the above problems and other problems, and it is one object of the present invention to provide a bumper reinforcing structure of an automobile, which is made of two different materials, so that an energy absorbing efficiency of impact energy can be maximized upon collision.

It is another objective to provide a bumper reinforcing structure of an automobile, which can be separated to separate subcomponents made of different materials, respectively, thereby making it easy to manufacture the bumper reinforcing structure and reducing manufacturing costs and maintenance costs thereof.

In accordance with an aspect of the present invention, the above and other objects can be accomplished by a bumper reinforcing structure of an automobile, including an impact beam, a mounting part connected to either end of the impact beam, and a connecting portion for connecting the impact beam and the mounting part to each other at either end of the impact beam, wherein the impact beam and the mounting part consist of two or more different materials.

### BRIEF DESCRIPTION OF THE DRAWINGS

The foregoing and other inventive features of will be more clearly understood from the following detailed description taken in conjunction with the accompanying drawings, in which:

FIG. 1 is a perspective view of a bumper reinforcing structure of an automobile according to one inventive embodiment;

FIG. 2 is a diagram illustrating a connecting portion of the bumper reinforcing structure of the automobile according to one embodiment;

FIG. 3 is a rear perspective view of the bumper reinforcing structure of the automobile according to one embodiment, when connecting the bumper reinforcing structure to a bumper face;

FIG. 4 is a front perspective view of the bumper reinforcing structure of the automobile according to one embodiment, when connecting the bumper reinforcing structure to a bumper face; and

FIG. 5 is a graphical representation depicting results of a test showing one effect of the bumper reinforcing structure of the automobile according to one embodiment.

### DESCRIPTION OF CERTAIN INVENTIVE EMBODIMENTS

Embodiments of the invention will now be described with reference to the accompanying figures, wherein like numerals refer to like elements throughout. The terminology used in the description presented herein is not intended to be interpreted in any limited or restrictive manner, simply because it is being utilized in conjunction with a detailed description of certain specific embodiments of the invention. Furthermore, embodiments of the invention may include several novel features, no single one of which is solely responsible for its desirable attributes or which is essential to practicing the inventions herein described.

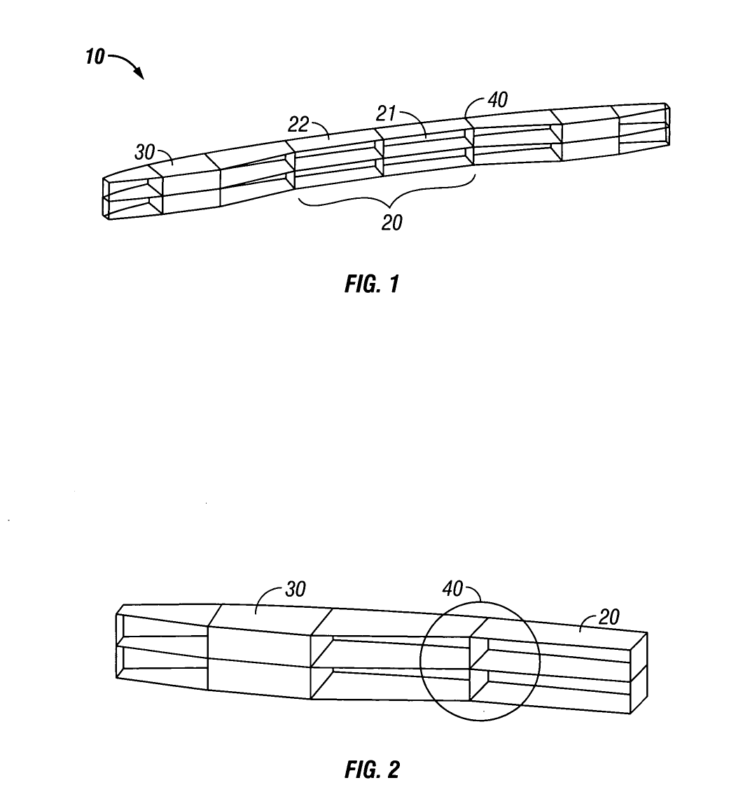

FIG. 1 shows a bumper reinforcing structure of an automobile according to one embodiment, which consists of two or more different materials. As shown in FIG. 1, the bumper reinforcing structure of the invention may include an impact beam 20, a mounting part 30 connected to either end of the impact beam 20, and a connecting portion 40 for connecting the impact beam 20 and the mounting part 30 to each other.

The impact beam 20 serves to receive an impact applied to the automobile from the outside at the front side thereof, and may be formed by a material having an elongation of lower than 15%, for example, metal such as high-tensile strength steel, or synthetic resin containing glass fiber such as GMT (Glassfiber Mat reinforced thermoplastics) and LFT (long glassfiber thermoplastics) or reinforced plastics. It may be desirable that the impact beam 20 be capable of sustaining an impact force generated at the moment of collision, and have a low deformation amount for the impact. Accordingly, the impact beam may be formed by a material having a high stiffness.

Although the impact beam 20 may be formed entirely of a single material, respective portions constituting the impact beam 20 may consist of different materials. For example, in an embodiment where the impact beam 20 has a C-shaped reinforcing rib, a vertical portion 21 of the impact beam 20 may be made of a metal having a high stiffness, and a horizontal portion 22 thereof, which is subjected to a relatively large deformation, may be made of a plastic material. Thus, the impact beam can absorb impact energy more effectively than the impact beam consisting entirely of metal, and significantly reduce the weight of the reinforcing structure.

In an embodiment where the impact beam may be made of the synthetic resin containing the glass fiber or the plastic when the impact beam is subjected to an impact, the center of the impact beam 20 tends to be broken, causing the impact to be mainly transmitted to structures at one side of the automobile. However, according to one embodiment of the impact beam 20, although the impact beam 20 can be bent due to the metallic portion of the impact beam, it is not broken. Accordingly, the impact beam 20 can connect structures at both sides of the automobile to each other upon collision.

The mounting part 30 serves to sustain the moment and the force caused by the collision applied to the impact beam 20 while supporting the impact beam 20. The mounting part 30 may also consist of a variety of materials, for example, metal, synthetic resin containing glass fiber, plastic or other suitable material. According to one embodiment, the mounting part 30 may be made of the same material as that of the impact beam 20 or a different material. In some embodiments, the plastic material used to make the mounting part 30 may have an elongation rate of 15-500%.

The mounting part 30 is connected to the impact beam 20, acting to sustain the impact applied to the impact beam 20, so that the deformation of the impact beam 20 by the amount of the impact beam 20 thrust into the mounting part 30 by the impact from the outside can be completely reflected to the mounting part 30. That is, the mounting part 30 is also bent toward the centerline of the automobile by a displacement of the impact beam 20 thrust thereto by the impact.

The impact beam 20 and the mounting part 30 absorb impact energy by an amount proportional to the square of the displacement thereof. Accordingly, the impact energy applied from the outside is not completely transmitted, but is absorbed in a considerable amount by the impact beam 20 and the mounting part 30.

Generally, to resist bending the mounting part 30, the mounting part 30 may consist of a material having a very high stiffness. However, material having a very high stiffness transfers the impact absorbed by the mounting part 30 to the body frame and this may provide less protection for a driver. To offer more protection for a driver, the mounting part 30 may include a deformable plastic material having high impact absorbency, according to one embodiment. During a collision, the mounting part 30 may absorb the force of a large impact, and therefore, transfer less force to the vehicle and the driver.

In an embodiment where the components of the bumper reinforcing structure 10, like the mounting part 30, are separately produced with different materials, even if the mounting part 30 is torn, deformed, or subjected to other damage during an impact, only the damaged mounting part 30 may need be replaced with a new one. Thus, it is more economical because the entire bumper reinforcing structure 10 of this embodiment may not require replacing; instead, only the damaged mounting part 30 need be replaced.

Where the mounting part 30 is made of the plastic material having a high impact absorbency, there is provided an advantageous effect in that the absorber, which is typically used for an impact absorption structure, can be omitted. Accordingly, not only can cost for mounting the absorber be reduced, but the space occupied by the absorber can also be reduced, decreasing the package space of the bumper, thereby providing an automobile having a more aesthetic appearance.

The bumper reinforcing structure 10 of the invention may be made of different materials in such a manner that the impact beam 20 may consist of a material having a high stiffness while the mounting part 30 may consist of a material having a low stiffness.

The mounting part 30 can be manufactured not only as a single component but also as several subcomponents consisting of different materials. For example, according to one embodiments where the mounting part 30 is formed entirely of a plastic material having low stiffness, if it is considered that the mounting part 30 does not satisfy some tests for testing the strength of the reinforcing structure, only a portion of the mounting part suffering a remarkably large deformation may be produced with the plastic material of the low stiffness while the other portions thereof are still made of the material having the high stiffness. Thus, the uses of multiple materials increases not only the overall strength of the mounting part 30 but also the energy absorbing efficiency of the impact from the outside.

A bumper mounting bracket is formed as an integral part of the mounting part 30 by injection molding according to one embodiment. After being produced with a different material, the bumper mounting bracket is added to the mounting part 30 by insert injection, thereby lowering the manufacturing costs.

In an embodiment case where the bumper reinforcing structure 10 is formed from two or more different materials and has the separate components produced by way of different processes according to the materials, the connecting portion 40 may connect the impact beam 20 and the mounting part 30 to each other. The connecting portion 40 may, for example, use a nut and bolt coupling structure, which can provide ease in operation as well as an increase in coupling strength.

According to one embodiment, the bumper reinforcing structure 10 has separate components produced by way of different processes according to the materials, the impact beam 20 and the mounting part 30 constituting the bumper reinforcing structure 10 may be produced separately. After making the impact beam 20 of various widths, lengths or strengths and the mounting part 30 of various configurations or strengths by way of the different processes, the manufacturer can connect the components, selected to correspond to specifications for the respective automobiles, to each other. Accordingly, according to one embodiment, it may be beneficial in that the bumper reinforcing structure 10 of the automobile can be mounted to any type of automobile.

The bumper reinforcing structure of the automobile can be manufactured as a single article fixedly preset for the respective type of automobile. According to one embodiment of the invention, the bumper reinforcing structure 10 of the automobile can be used for any type of automobile.

In the case where the bumper reinforcing structure 10 of the automobile has the components produced by way of the different processes according to the materials thereof, the impact beam 20 and the mounting part 30 may be connected to each other by the connecting portion 40. FIG. 2 illustrates a connecting portion 40 of the bumper reinforcing structure 10, according to one embodiment, where the impact beam 20 and the mounting part 30 have structures that overlap in the connecting portion 40 and can be fastened together. Although the impact beam 20 and the mounting part 30 can be connected to each other in the connecting portion 40 by various means, such as welding, fitting, bolt coupling, insert injection, ultrasonic welding or the like, it may be preferable to use a bolt coupling structure, since the bolt coupling structure allows an easy operation as well as an increase in coupling strength.

Using the bolt coupling structure may help the driver reduce time and costs for maintaining the bumper reinforcing structure 10 of the automobile.

In the case where the bumper reinforcing structure 10 of the automobile according to the present invention has the components produced by way of the different processes according to the materials thereof, the impact beam 20 and the mounting part 30 constituting the bumper reinforcing structure 10 can be separated. When either the impact beam 20 or the mounting part 30 is damaged, only the damaged component may be replaced with a new one, instead of replacing the entire bumper reinforcing structure 10 with a new one. Accordingly, the costs for maintaining the bumper reinforcing structure 10 of the automobile can be remarkably reduced when compared with that of the conventional bumper reinforcing structure.

For example, when the impact beam 20 of the bumper reinforcing structure 10 of the invention is damaged by an impact from the outside, the damaged impact beam 20 is removed therefrom and replaced with a new impact beam 20. At this time, if the impact beam 20 is connected to the mounting part 30 by the bolt coupling structure, a serviceman can easily replace the impact beam 20 with a new one.

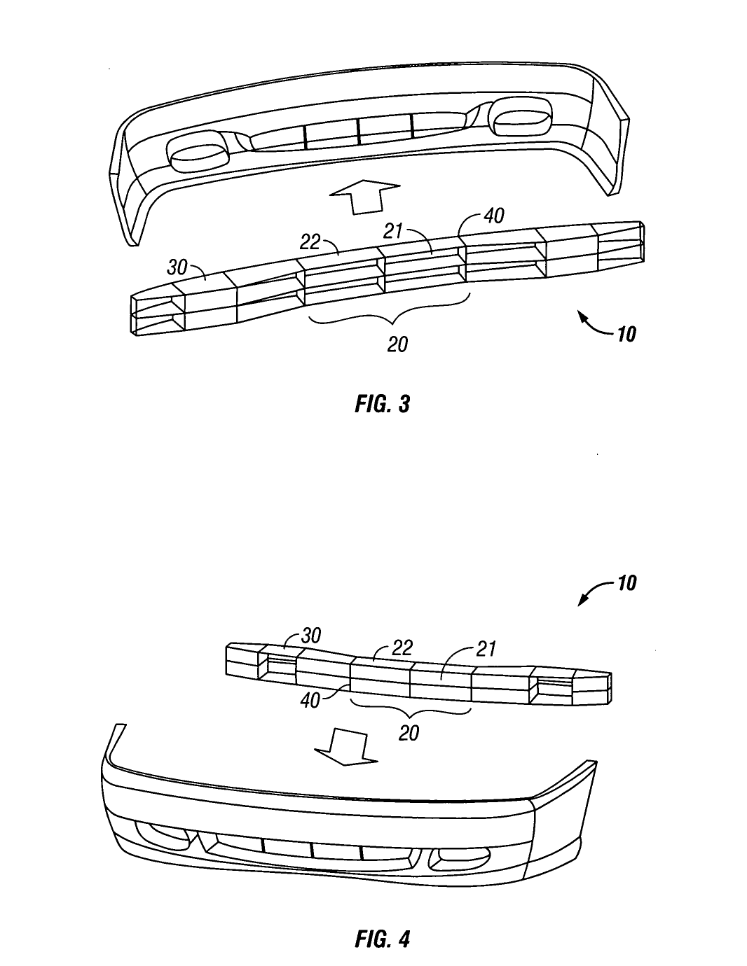

As illustrated in FIGS. 3 and 4, the bumper reinforcing structure 10 may be aligned to the bumper face to provide a complete bumper system. FIG. 3 illustrates a rear perspective view of the bumper reinforcing structure 10 and a corresponding bumper 50, according to one embodiment. FIG. 4 illustrates a front perspective view of the bumper reinforcing structure 10 and a corresponding structure 10, according to one embodiment.

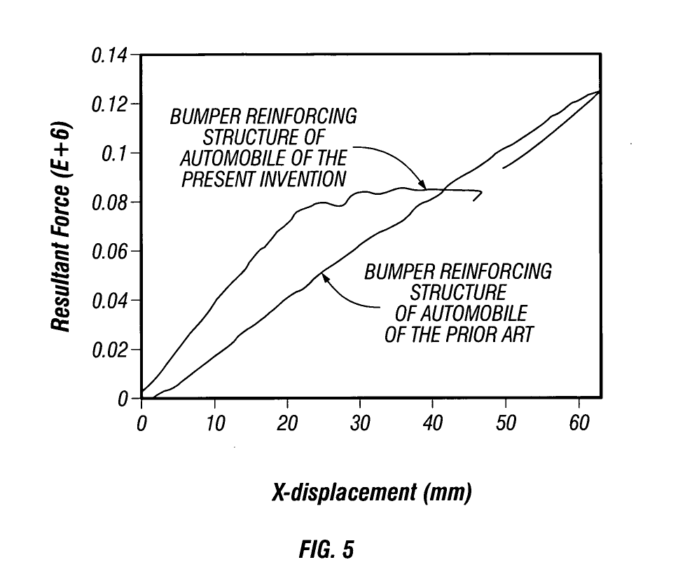

FIG. 5 is a graphical representation depicting results of a test to demonstrate an effect of the bumper reinforcing structure of the automobile according to one embodiment of the invention. In this embodiment, the impact beam was made of the material “Verton” manufactured by GE company, which is LFT containing 30% glass fiber, and the mounting part was made of the material “Xenoy” manufactured by GE company. The impact beam and the mounting part were produced by injection molding and they were connected to each other by insert injection. As can be seen from the relation between reacting force and deformation shown in FIG. 5, the structure of the tested embodiment absorbs the same impact energy as that of the conventional structure, while having a lower deformation amount and force compared with the conventional structure. That is, it can be seen that the bumper reinforcing structure of the invention has an excellent energy absorbing efficiency, compared with the conventional structure.

As apparent from the above description, with the bumper reinforcing structure 10, according to some embodiments, formed from two or more different materials, characteristics of the respective materials can be maximally utilized, thereby maximizing the energy absorbing efficiency upon collision.

When using the bumper reinforcing structure 10, the absorber may be omitted, ensuring reduction of space occupied by the absorber as well as reduction in the manufacturing costs, leading to an enhancement of the appearance of the automobile.

There is a benefit in the bumper reinforcing structure 10 formed from two or more different materials, wherein the bumper reinforcing structure 10 of the automobile has separate components produced by way of separate processes according to the materials. As the impact beam and the mounting part can be separately produced and connected to each other, these components can be formed easily by press molding or injection molding. Thus, the entire process for manufacturing the reinforcing structure becomes easy and the manufacturing costs thereof can be reduced.

Further, after being manufactured into various shapes and materials, the impact beam 20 and the mounting part 30 can be selectively connected to each other, so that the bumper reinforcing structure 10 of the automobile may be compatible with any type of automobile. In contrast, the conventional bumper reinforcing structure of an automobile must be manufactured as a single article predetermined for the respective kind of automobile.

The impact beam 20 and the mounting part 30 of the bumper reinforcing structure 10 of the automobile can be connected or disconnected as an independent component. Thus, when one of the impact beam or the mounting part is damaged, only the damaged component needs to be replaced. Not replacing the entire bumper reinforcing structure leads to a reduction in costs for maintaining the automobile.

The impact beam 20 and the mounting part 30 can be easily connected or disconnected, using the coupling structure for the connecting portion 40 of the bumper reinforcing structure 10, allowing an easy replacement operation.

It should be understood that the embodiments and the accompanying drawings as described above have been described for illustrative purposes and the present invention is limited only by the following claims. Further, those skilled in the art will appreciate that various modifications, additions and substitutions are allowed without departing from the scope and spirit of the invention as set forth in the accompanying claims.

1. A bumper reinforcing structure of an automobile, comprising:
an impact beam with a first and second end;
a first mounting part connected to the first end of the impact beam;
a second mounting part connected to the second end of the impact beam;
a first connecting portion connecting the first end of the impact beam and the first mounting part; and
a second connecting portion connecting the second end of the impact beam and the second mounting part,
wherein the impact beam is formed from at least a first material and the mounting part is formed from at least a second material, wherein the first and second materials are different materials.

2. The bumper reinforcing structure of claim 1, wherein the impact beam and the mounting part is formed from a material having a high strength, and wherein each mounting part comprises a portion formed from a flexible material.

3. The bumper reinforcing structure of claim 2, wherein the material having a high strength is metal, and wherein the portion of each mounting part is plastic.

4. The bumper reinforcing structure of claim 2, wherein the material having a high strength is synthetic resin containing glass fiber, and wherein the portion of each mounting part is plastic.

5. The bumper reinforcing structure of claim 1, wherein the impact beam and each mounting part have various lengths and widths, respectively.

6. The bumper reinforcing structure of claim 1, wherein the impact beam is formed from a material having a high strength, and each mounting part is formed from a flexible material.

7. The bumper reinforcing structure of claim 6, wherein the impact beam is formed from a metal or synthetic resin containing glass fiber, and wherein each mounting part is formed from a plastic.

8. The bumper reinforcing structure of claim 6, wherein the impact beam is formed from a synthetic resin containing glass fiber, and wherein each mounting part is formed from a plastic.

9. The bumper reinforcing structure of claim 1, wherein the mounting part is integrally formed with a bumper mounting bracket.

10. The bumper reinforcing structure of claim 1, wherein the mounting part is formed with a bumper mounting bracket by insert injection.

11. The bumper reinforcing structure of claim 1, wherein a first portion of the impact beam comprises metal and a second portion of the impact beam comprises a flexible material.

12. The bumper reinforcing structure of claim 1, wherein the flexible material is plastic.

13. The bumper reinforcing structure of claim 1, wherein the impact beam and the first and second mounting parts are manufactured separately and wherein the connecting portion comprises fasteners for connecting the impact beam and the first and second mounting part.

14. The bumper reinforcing structure of claim 13, wherein the fasteners comprise a bolt coupling structure.

15. The bumper reinforcing structure of claim 13, wherein the fasteners comprise a fitting structure.

16. The bumper reinforcing structure of claim 13, wherein the connecting portion is formed by insert injection.

17. The bumper reinforcing structure of claim 13, wherein the connecting portion is formed by ultrasonic welding.

18. The bumper reinforcing structure of claim 6, wherein the mounting part comprises plastic having an elongation rate of 15-500%.

19. The bumper reinforcing structure of claim 1, wherein the impact beam comprises synthetic resin containing glass fiber such as Glassfiber Mat reinforced thermoplastics (GMT) and long glassfiber thermoplastics (LFT).

20. The bumper reinforcing structure of claim 1, wherein the impact beam comprises Vertron.

21. The bumper reinforcing structure of claim 1, wherein the mounting part comprises Xenoy.

22. A bumper reinforcing structure of an automobile, comprising:
means for receiving an impact to the bumper on a stiff surface that moves under the impact; and
means for deflecting the movement of the means for receiving an impact such that the impact is absorbed by said means for deflecting.

23. A bumper reinforcing structure of an automobile, comprising:
impact member made of a high strength material;
one or more mounting members for connecting the impact member to the automobile frame, wherein the mounting member is formed from a material having less strength and greater flexibility that the impact member.

24. The bumper reinforcing structure of claim 23, further comprising one or more connecting portions, said one or more connecting portions connecting the impact member to the one or more mounting members.
